(19) United States
(12) Patent Application Publication
(10) Pub. No.: US 2011/0210598 A1
(43) Pub. Date: Sep. 1, 2011

(54) RESTRAINT SYSTEM FOR VEHICLE

(76) Inventor: David Kovac, Warren, MI (US)

(21) Appl. No.: 13/030,049

(22) Filed: Feb. 17, 2011

Related U.S. Application Data
(60) Provisional application No. 61/305,788, filed on Feb. 18, 2010.

(51) Int. Cl. B60R 22/00

(52) U.S. Cl. 297/466; 297/464

(57) ABSTRACT

An apparatus and for restraining occupants of a vehicle is disclosed, the apparatus having a rigid member configured to restrain an upper or lower body portion of an individual located in the vehicle. The individual moves within a range of motion that is represented by an area of movement. The rigid member is capable of movement between a stowed position and a deployed position. The upper body portion or the lower body portion is restrained by the rigid member only in the deployed position. A locking mechanism for locking the rigid member in the stowed position and the deployed position is provided. A release mechanism activates the locking mechanism. The release mechanism is located at a predetermined distance from the locking mechanism such that the release mechanism is located outside of the area of movement.

### CROSS REFERENCE TO RELATED APPLICATIONS

This application claims the benefit of U.S. Provisional Patent Application Ser. No. 61/305,788 filed Feb. 18, 2010, the contents of which are incorporated herein by reference thereto.

### BACKGROUND

Exemplary embodiments of the present invention relate to restraint systems for use with vehicles.

Current police vehicles use standard seat belt systems to secure detainees in the back of the police vehicle. Referring to FIG. 1, the current approach for restraining handcuffed detainees is through the use of a seat belt 102 constructed out of a flexible material with a buckle. These devices permit relative movement between the occupant and the belt, except in a collision wherein a tensioner cinches the belt and inhibits excessive movement. In a police vehicle the objective is to maximize restraint, where necessary, and to provide for a safe environment for the officer as well as the detainee, and other persons within close proximity to the vehicle.

Accordingly, it is desirable to provide a restraint system for a vehicle that addresses the aforementioned needs.

### SUMMARY OF THE INVENTION

In accordance with an embodiment of the present invention a restraint system for a body portion of an individual located in a vehicle is provided. The individual moves within a range of motion that is represented by an area of movement. The restraint system includes a rigid member configured to selectively restrain the body portion. The rigid member is capable of movement between a stowed position and a deployed position, where the body portion is restrained by the rigid member only in the deployed position. A locking mechanism is provided for locking the rigid member in the stowed position and the deployed position. A release mechanism for activating the locking mechanism is provided. The release mechanism is located at a predetermined distance from the locking mechanism such that the release mechanism is located outside of the area of movement.

In accordance with another embodiment of the present invention a restraint system for an upper body portion of an individual located in a vehicle is provided. The restraint system allows the individual to move within a range of motion that is represented by an area of movement. A rigid member configured to selectively restrain the upper body portion is provided. The rigid member is capable of movement between a stowed position and a deployed position. The upper body portion is restrained by the rigid member only in the deployed position. A locking mechanism is provided for locking the rigid member in the stowed position and the deployed position. A release mechanism for activating the locking mechanism is provided. The release mechanism is located at a predetermined distance from the locking mechanism such that the release mechanism is located outside of the area of movement.

In accordance with yet another embodiment of the present invention restraint system for a lower body portion of an individual located in a vehicle is provided. The individual moves within a range of motion that is represented by an area of movement. A rigid member configured to restrain a lower body portion of an individual located in the vehicle is provided. The rigid member is capable of movement between a stowed position and a deployed position. The lower body portion is restrained by the rigid member only in the deployed position. A locking mechanism is provided for locking the rigid member in the stowed position and the deployed position. A release mechanism for activating the locking mechanism is provided. The release mechanism is located at a predetermined distance from the locking mechanism such that the release mechanism is located outside of the area of movement.

Additional features and advantages of the various aspects of exemplary embodiments of the present invention will become more readily apparent from the following detailed description in conjunction with the drawings wherein like reference numerals refer to corresponding parts in the several views.

### BRIEF DESCRIPTION OF THE DRAWINGS

FIG. 1 is an illustration of a vehicle including a prior art seatbelt;

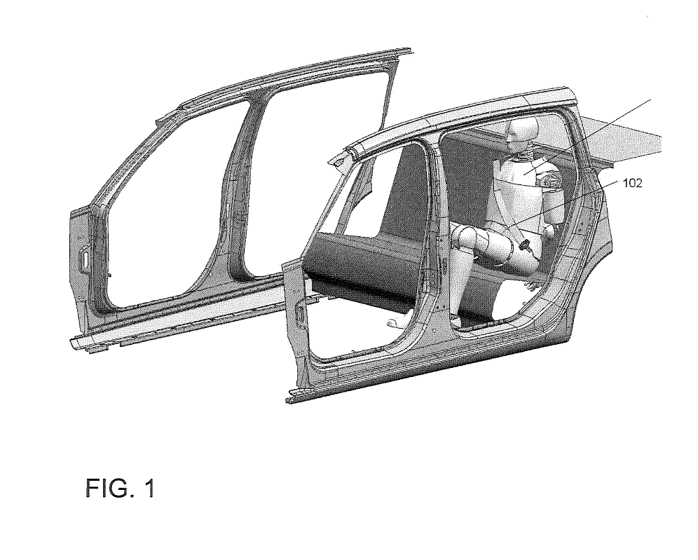

FIG. 2 is an illustration of a torso restraint system in a vehicle, where the torso restraint system is in a stowed position;

FIG. 3 is an illustration of the torso restraint system shown in FIG. 2 in a deployed position;

FIG. 4A is an exploded view of the torso restraint system shown in FIG. 1;

FIG. 4B is a perspective view of the torso restraint system shown in FIG. 1;

FIG. 5A is an enlarged cross-sectional view of a portion of the torso restraint system shown in FIG. 1 in the deployed position;

FIG. 5B is an enlarged cross-sectional view of a portion of the torso restraint system shown in FIG. 1 in the stowed position;

FIG. 6 is an illustration of release mechanism for activating the torso restraint system shown in FIG. 1;

FIG. 7 is a cross-sectional view if the release mechanism shown in FIG. 6;

FIG. 8 is an illustration of a leg restraint system in a vehicle, where the leg restraint system is in a stowed position;

FIG. 9 is an illustration of the leg restraint system shown in FIG. 8 in a deployed position;

FIG. 10A is an exploded view of the leg restraint system shown in FIG. 8;

FIG. 10B is a perspective view of the leg restraint system shown in FIG. 8;

FIG. 11 is an enlarged view of a portion of the leg restraint system shown in FIG. 8 in the deployed position;

FIG. 12 is an illustration of release mechanism for activating the leg restraint system shown in FIG. 8; and

FIG. 13 is a cross-sectional view of the release mechanism shown in FIG. 12.

Although the drawings represent varied embodiments and features of the present invention, the drawings are not necessarily to scale and certain features may be exaggerated in order to illustrate and explain exemplary embodiments the present invention. The exemplification set forth herein illustrates several aspects of the invention, in one form, and such exemplification is not to be construed as limiting the scope of the invention in any manner.

### DETAILED DESCRIPTION OF EXEMPLARY EMBODIMENTS

Various embodiments of the present invention relate to a restraint system for an occupant of a vehicle and in particular some embodiments are directed to a restraint system for law enforcement or military vehicles.

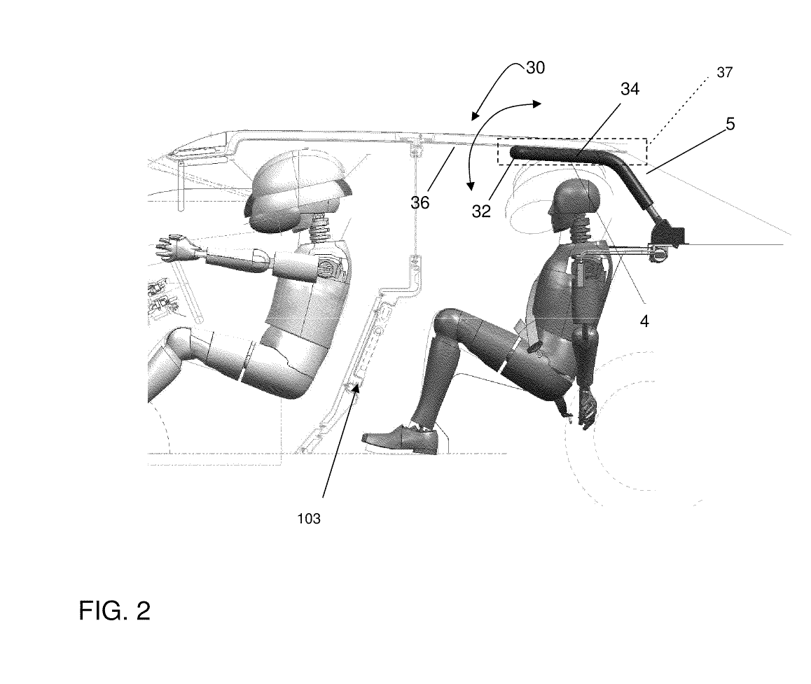

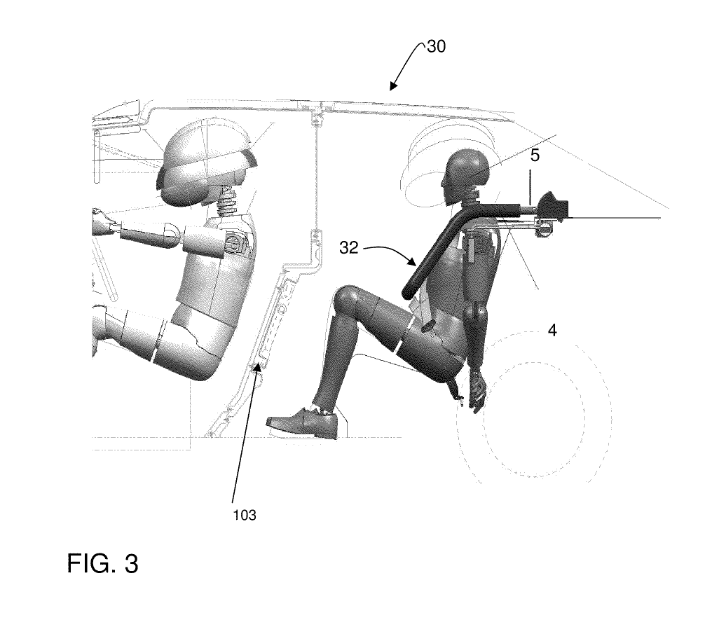

Referring now to FIGS. 2-3 a Torso Restraint System (TRS) 4 in accordance with a non-limiting embodiment of the present invention is illustrated in a vehicle 30. In one non-limiting embodiment, the torso restraint system 4 can be packaged in any passenger vehicle environment such as, for example, a police vehicle and is capable of moving from a stowed position to an active or deployed position. The torso restraint system 4 selectively restrains an upper body portion of an individual located in the vehicle 30 when it is in the active or deployed position. FIG. 2 is an illustration of the torso restraint system 4 having a primary or rigid member 5 in the stowed position, and FIG. 3 is an illustration of the rigid member 5 in the active or deployed position. In one non-limiting configuration, the rigid member 5 is “U” shaped to surround an upper portion of a vehicle occupant. The rigid member 5 selectively contacts and restrains the upper body of the individual. The rigid member 5 is also sized to fit within an interior cabin of the vehicle 30. In one embodiment, the rigid member 5 and a head liner 36 of the vehicle are configured such that most of the rigid member is received within a recessed area 37 of the vehicle when it is in the stowed position. In one embodiment, the rigid member 5 comprises a bent tubing constructed of a metal based material such as, for example, steel. The rigid member 5 may also include an outer casing 32 for providing a pliable interface with the upper body of the individual. The outer casing 32 may be constructed from any type of flexible, elastic or pliable material such as, for example, an open cell or closed cell foam.

Referring to FIG. 2, the rigid member 5 of the torso restraint system 4 does not generally restrain the upper body of the individual when it is in the stowed position. Instead, the rigid member 5 is positioned above and does not generally make contact with the individual allowing the individual to enter and exit the vehicle. In the embodiment as shown, a front portion 34 of the rigid member 5 is positioned to be generally parallel and does not interfere with the headliner 36 of the vehicle 30 and as discussed above is received within an area 37 of the upper portion of the vehicle. In one embodiment, the area 37 is recessed within the upper portion of the vehicle. Turning now to FIG. 3, the rigid member 5 of the torso restraint system 4 generally restrains the upper body portion of the individual when in the active position. Thus, when in the active position the torso restraint system 4 provides for enhanced securing of the individual in the vehicle 30 by restricting upper body motion of the individual.

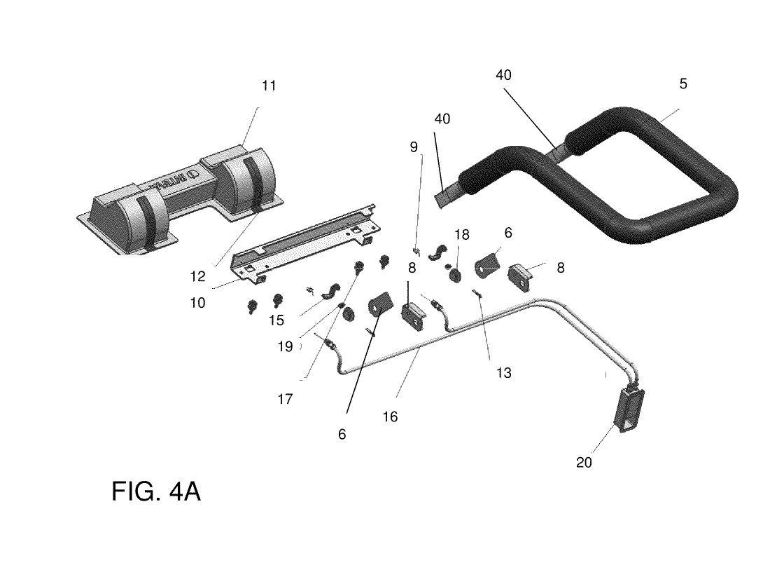

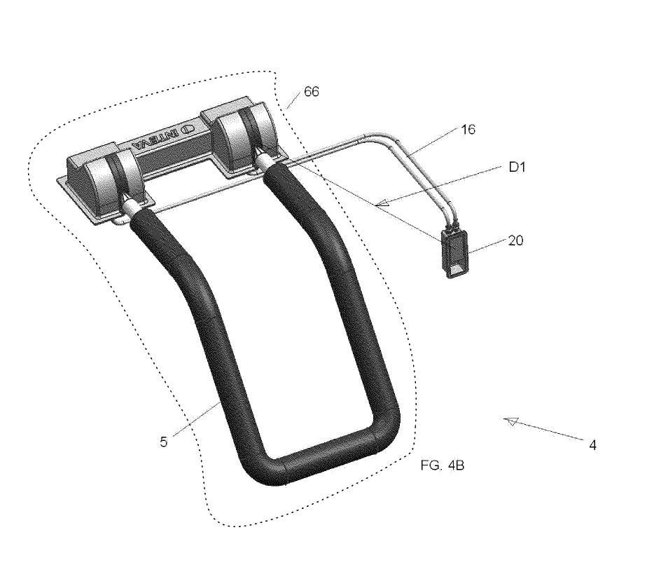

FIG. 4A is an exploded view of the torso restraint system 4 and FIG. 4B is an illustration of the assembled torso restraint system 4. Referring to FIG. 4A, the torso restraint system 4 includes at least one locking plate 6, at least one pivot mounting bracket 8, at least one locking arm spring 9, an attachment bracket 10, a restraint housing 11, a gasket 12, at least one spring 13, at least one locking arm 15, at least one cable 16, mechanical fasteners 17, mechanical fasteners 18, at least one locking arm pivot pin 19, and a remote activation device 20. In one non-limiting embodiment, a pair of locking plates 6, a pair of pivot mounting brackets 8, a pair of locking arm springs 9, a pair of springs 13, a pair of locking arms 15, a pair of cables 16 are provided for securement to each end 40 of the rigid member 5 to retain it in the stowed position and the deployed position as will be discussed herein.

In one embodiment, the locking plate 6, the locking arm spring 9, the spring 13 and the locking arm 15 cooperate to create portions of a locking mechanism for securing the rigid member 5 in the stowed position (FIG. 2) and the deployed position (FIG. 3). The locking mechanism is then coupled to a release mechanism via a cable or cables to release the same.

The rigid member 5 includes left and right handed attachment portions 40 that are each attached to a locking plate 6. It should be noted that while FIG. 4A illustrates both of the left and right handed attachment portions 40 each having a corresponding locking mechanisms, it is understood that in another embodiment the locking mechanism could be included on only one of the attachment portions 40 as well. It should also be noted that while two cables 16 are illustrated, only one cable 16 may be included as well, wherein the single cable is used to release each of the locking mechanisms by moving a single item coupled to each of the locking mechanisms.

Still further, the aforementioned components are merely illustrative of one non-limiting locking mechanism and torso restraint system and other equivalent configurations are configured to be within the scope of exemplary embodiments of the present invention.

The torso restraint system 4 also includes a restraining housing 11 that includes an aesthetic covering. A gasket 12 attaches to the restraining housing 11 with integral fastening features (not shown). The housing 11 and gasket 12 is employed to conceal the locking mechanism of the torso restraint system 4, and can be affixed to the vehicle 30 (FIGS. 2-3) in a multitude of methods (snap-in, mechanical fasteners, etc.). Gasket 12 and housing 11 are configured to allow the rigid member 5 to move between the stowed position and the deployed position.

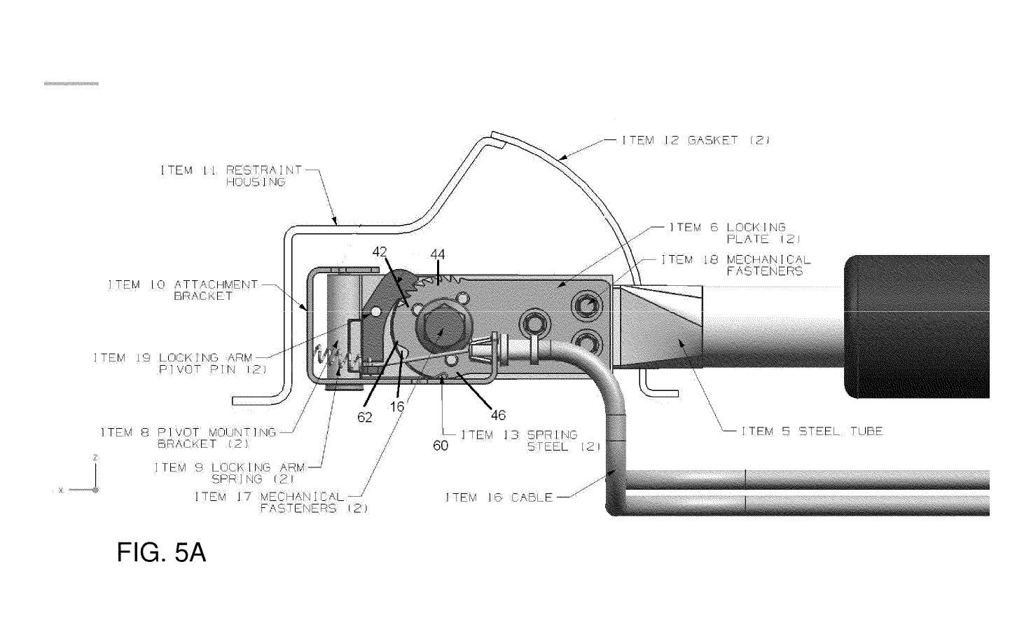

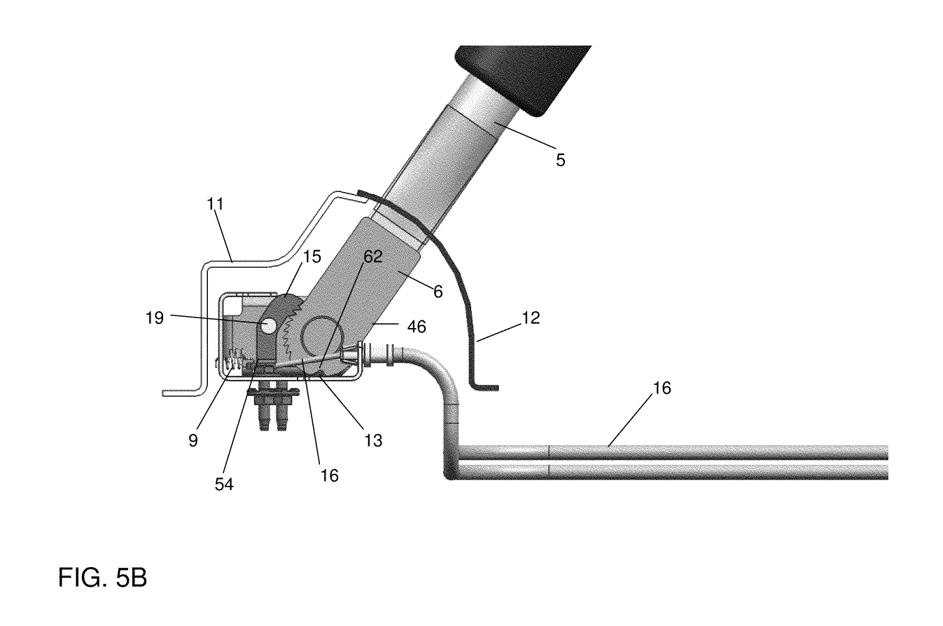

Referring now to both FIGS. 4A and 5, during assembly of the torso restraint system 4 the left and right handed attachment portions 40 of the rigid member 5 are secured to a complimentary locking plate 6 that is pivotally secured to pivot mounting brackets 8 by a plurality mechanical fasteners 18, 19 such that rigid member can move or pivot between the stowed and deployed positions.

In one non-limiting embodiment, a pair of subassemblies each comprising an end portion 40 of the rigid member 5 and the locking plate 6 is pivotally attached to a corresponding pivot mounting bracket 8 via any suitable attachment means such as welding, which allows pivotal movement of the rigid member with respect to the mounting bracket 8 or any other equivalent member of the restraint system. Each of the pair of subassemblies is secured to the attachment bracket 10 with mechanical fasteners 17. Of course, other configurations are contemplated for example and in one alternative locking plate and pivot bracket may be integrally formed with the ends 40 of the rigid member 5.

A locking arm 15 is pivotally secured to each of the pivot mounting brackets via a pivot pin 19. Each locking arm 15 is configured for movement between a locking position and a release position. The locking arm 15 is biased into the locking position by a biasing member such as a spring 9 that is secured to the attachment bracket 10 at one end and the locking arm 15 at the other end. When the locking arm 15 is in the locking position a plurality of teeth or features 42 engage corresponding teeth or features 44 on the locking plate.

FIG. 5A is an illustration of the rigid member 5 in the deployed position wherein the locking arm 15 is illustrated in the locking position and the locking arm 15 has pivoted or rotated about the locking arm pivot pin 19 from the release position to the locking position. In this position, the locking arm 15 and the locking plate 6 selectively engage with one another through the plurality of teeth or features 42 that engage complimentary teeth or features 44 on the locking plate.

More specifically and in one non-limiting embodiment, the locking arm 15 includes a first engagement feature 42, and the locking plate 6 includes a second engagement 44 feature. The first and second engagement features 42, 44 selectively engage with one another. In the illustrated embodiment, the first and second engagement features 42, 44 are angled mating teeth, however it is understood that other features that can selectively lock and unlock from one another may be used as well. Specifically, when the rigid member 5 is in the deployed position as shown in FIG. 5, the first engagement feature 42 of the locking arm 15 interlocks with the second engagement feature 44 of the locking plate 6 and secures the rigid member 5 in the deployed position. Accordingly, the locking plate 6 and the locking arm 15 perform as a pawl and ratchet assembly.

When the rigid member 5 is actuated into the stowed position (shown in FIG. 5B), the first engagement feature 42 is disengaged from the second engagement feature 44. As mentioned above, each locking arm 15 is pivotable about the locking arm pivot pin 19 and is biased by a locking arm spring 9 into the locking position to act as a pawl that selectively engages with the restraint locking plate 6 as the plate 6 is pivoted with the rigid member as it is moved into the deployed position.

In order to release the locking arm 15 from the locking position and allow the rigid member 5 to be moved back into the stowed position. A pair of cables 16 are secured to each locking arm 15 at one end and a release mechanism or remote activation device 20 at the other end. In one embodiment, both cables 16 are secured to a lever paddle 22 pivotally mounted to the release mechanism such that as the lever paddle 22 is rotated, each cable 16 is retracted and the locking arm 15 or locking member 15 is pivoted into the release position by over coming the biasing force of the locking arm spring 9 and thus the rigid member 5 can be moved into the stowed position. Once the lever paddle 22 is released a spring 23 returns the lever paddle 22 to an un-actuated position and the cables 16 allow the locking arm or member 15 to rotate or pivot back into the locking position.

In order to retain the rigid member 5 in the stowed position, a spring or steel spring 13 integral with the housing 10 engages a detent 62 in the locking plate 6 such that the rigid member 5 is stored in the non-use or stowed position. In one embodiment spring 13 is a resilient portion of the attachment bracket configured to engage the locking plate 6 as it is rotated.

As illustrated in FIGS. 5A-5B, a portion of an outer surface 46 of the locking plate 6 engages with the spring 13 to secure the rigid member 5 in place in the stowed position. In the embodiment and as shown the FIGS., the outer surface 40 of the locking plate 6 includes a first detent 60 and a second detent 62. When the rigid member 5 is in the deployed position as shown in FIG. 5A the first detent 60 engages with the spring 13. When the rigid member 5 is in the stowed position as shown in FIG. 5B, the spring 13 engages with the second detent 62. Of course, the locking plate 6 may be configured to engage spring 13 when it is in the stowed position since locking member 15 also engages the locking plate 6 in the deployed position. Thus, the rigid member 5 is retained in the stowed position until a force sufficient to overcome the biasing force of spring 13 is applied to move the rigid member 5 into the deployed position.

In one embodiment, the activation or positioning of the torso restraint system 4 into the deployed position (shown in FIG. 3) is manually operated by simply applying a downward force (e.g., toward the floor of the vehicle) to the rigid member 5 to disengage spring 13 and move the rigid member 5 into the deployed position. Once in the deployed position, locking member 15 engages the locking plate 6 and the rigid member 5 is retained in the deployed position until the locking member or arm 15 is released via movement of cables 16.

Referring now to FIG. 4B, the disengagement of the locking members 15 or the locking mechanism of an exemplary embodiment of the torso restraint system is accomplished via cables 16 that are, as mentioned above, secured to the locking members or arms 15 at one end and a remote activation device 20, which is located at a remote location. The remote activation device 20 is positioned such that the remote activation device 20 cannot be accessed by the individual (shown in FIG. 3) that is restrained in the torso restraint system 4. This is because the individual restrained in the torso restraint system 4 has a limited range of motion that is represented by area 66 (FIG. 4B) when the rigid member 5 is in the deployed position. That is, the rigid member 5 limits movement of the upper body portion of the individual when in the deployed position to the area 66.

Thus, the individual cannot generally move his upper torso or arms outside of area 66. The release mechanism 20 is located in a remote location that is a predetermined distance D1 from the locking mechanism of the torso restraint system 4 such that the release mechanism 20 is outside of the range of motion. Thus, the individual restrained within the torso restraint system 4 is unable to grasp the activation device 20 when the rigid member 5 is in the deployed position. In another embodiment, the activation device 20 may be located in a forward compartment of the vehicle 30 that is separated from the rearward compartment where the restraint device and the restrained individual is located.

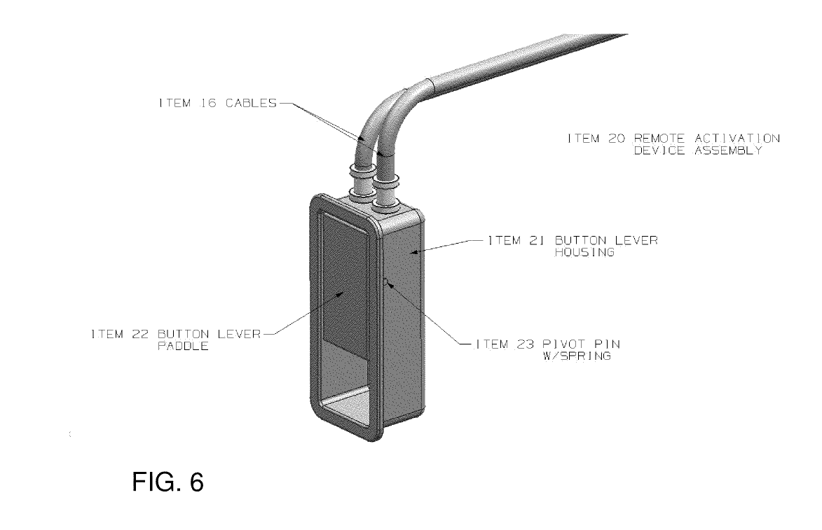

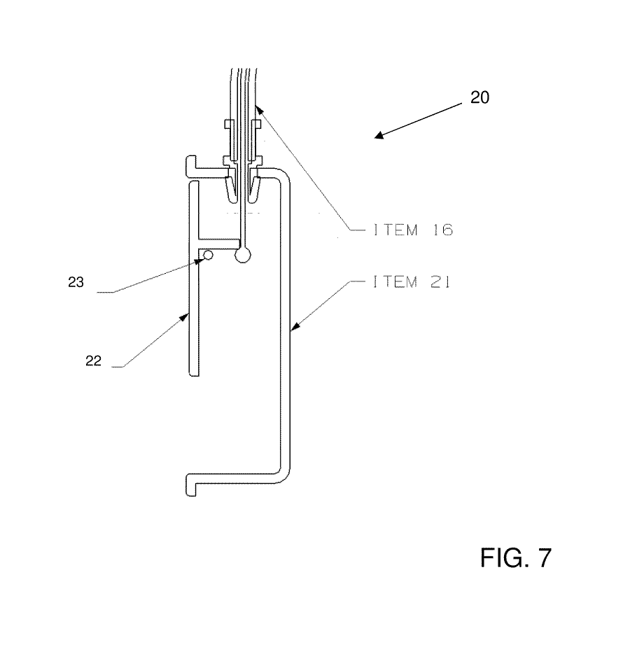

Referring now to FIGS. 6-7, cables 16 pass through an opening located within in a button lever housing 21 and are secured to lever paddle 22 pivotally secured to the button lever housing 21 by a mechanical fastening system 23. In one embodiment, the mechanical fastening system 23 is a pivot pin and spring assembly such that the lever paddle 22 may be pivoted away from the housing 21 and pull the cables such that locking member or arm 15 is rotated. Thereafter and upon release of the lever paddle 22 the spring 23 will return the lever paddle 22 and the cables 16 back to the unreleased position and the locking arm or member 15 once again moves back to the locking position. Still further and in another alternative embodiment, the release mechanism may be an electronic mechanism wired or wirelessly coupled to an electronic device such as a solenoid (not shown) that moves the locking member or arm 15 when a button of the release mechanism is activated.

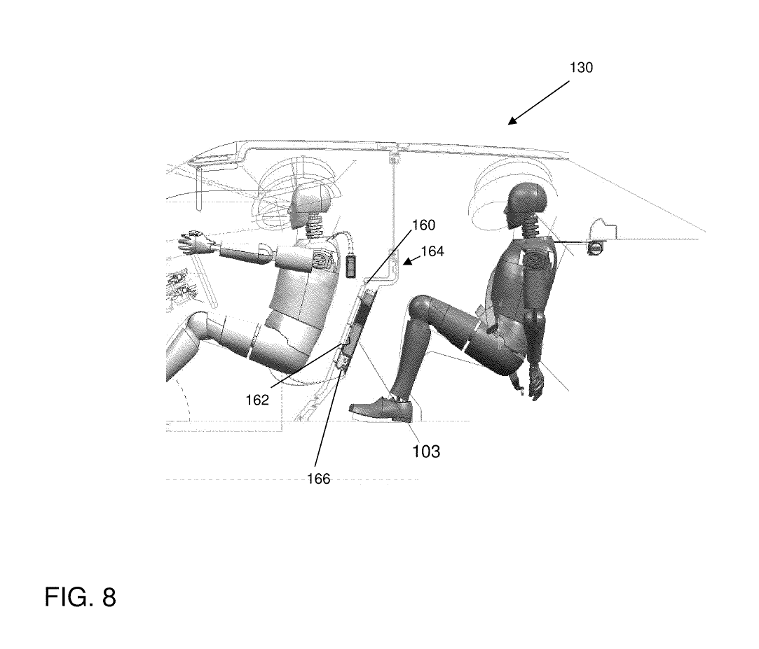

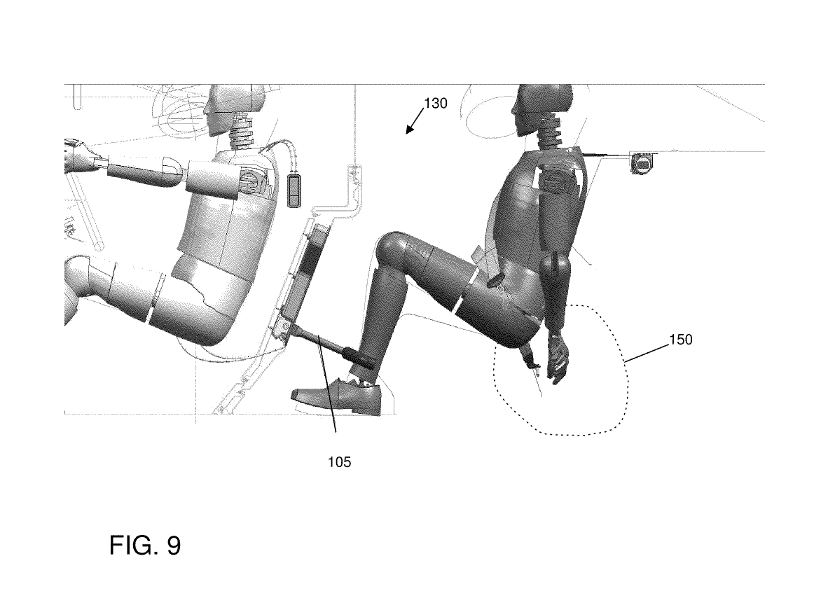

FIGS. 8-13 illustrate another embodiment of the present invention. Here a leg restraint system 103 is also illustrated in a vehicle 130. In one non-limiting embodiment, the leg restraint system 103 can be packaged in any passenger vehicle environment such as, for example, a law enforcement or military vehicle. In addition, the leg restraint system 103 can be used alone or in combination with the aforementioned torso restraint system 4. The leg restraint system 103 selectively restrains the legs or a lower body portion of an individual located in the vehicle 130. FIG. 8 is an illustration of the leg restraint system 103 having a primary or rigid member 105 in a stowed position, and FIG. 9 is an illustration of the rigid member 105 in an active or deployed position. The rigid member 105 selectively contacts and restrains the lower body portion of the individual. The rigid member 105 is also sized to fit within an interior cabin of the vehicle 130. In one non-limiting configuration, the rigid member 105 has a “U” shaped portion to surround a portion of the legs of a vehicle occupant.

Referring to FIG. 8, the rigid member 105 of the leg restraint system 103 does not generally restrain the lower body of the individual when in the stowed position. Turning now to FIG. 9, the rigid member 105 of the leg restraint system 103 generally restrains the lower body portion of the individual when in the deployed position such that the individual may enter and exit the vehicle 130 without interference. Thus, when in the deployed position the leg restraint system 103 provides for enhanced securing of individuals in the vehicle 130 by restricting lower body motion of the individual. The individual is typically handcuffed or restrained such that the individual has a limited range of motion that is represented by an area 150.

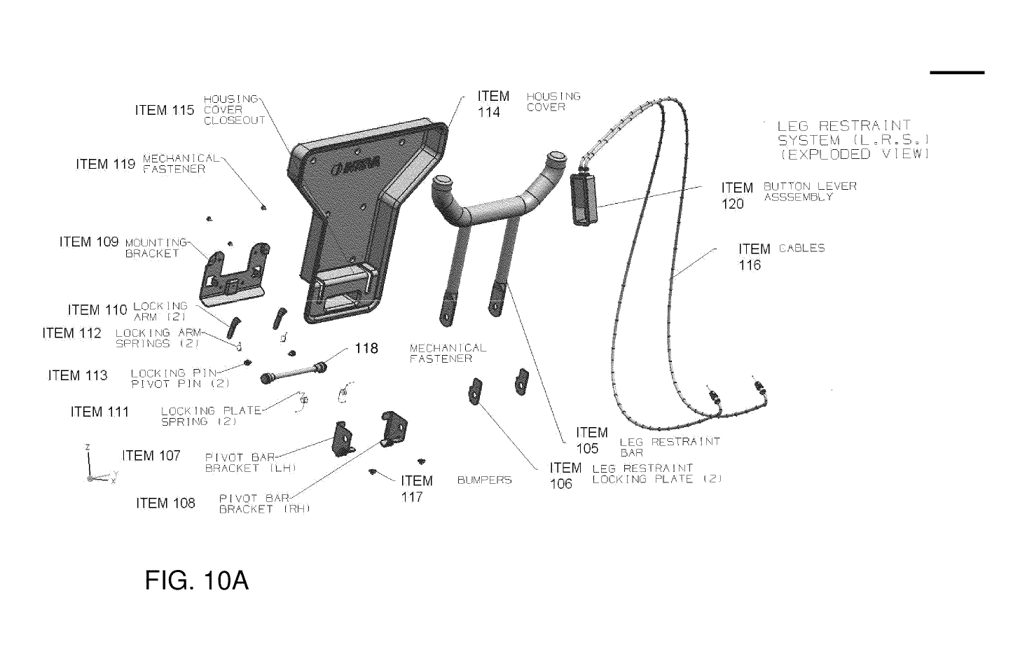

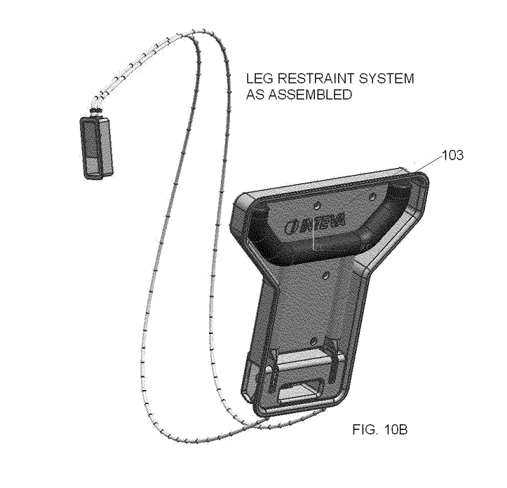

FIG. 10A is an exploded view of the leg restraint system 103 and FIG. 10B is an illustration of the assembled leg restraint system 103. Referring now to FIG. 10A, the leg restraint system 103 includes the rigid member 105, a leg restraint locking plate 106, a left hand pivot bar bracket 107, a right hand pivot bracket 108, a mounting bracket 109, at least one locking arm 110, at least one locking plate spring 111, at least one locking arm spring 112, at least one locking pivot pin 113, a housing cover 114, a housing cover closeout 115, at least one cable 116, a set of bumpers 117, mechanical fasteners 118, mechanical fasteners 119, and a button lever assembly 120.

At least the leg restraint locking plate 106, the locking arm 110, the locking plate spring 111 and the locking arm spring 112 cooperate to create a locking mechanism for locking the arms of the rigid member 105 in the stowed position (FIG. 8) and the deployed position (FIG. 9). It should be noted that while FIG. 10A illustrates a left hand side and a right hand side (as viewed from the seated individual) locking mechanism, the leg restraint system 103 may include one locking system on either the left or right hand side as well. It should also be noted that while two cables 116 are illustrated, a single cable 116 may be used as well.

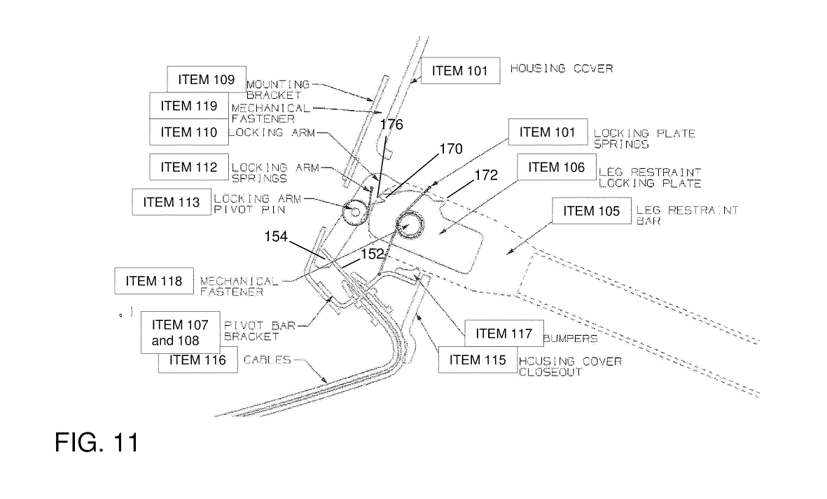

Referring now to both of FIGS. 10A and 11, during assembly of the leg restraint system 103 the rigid member 105 is attached to the leg restraint locking plate 106. In one approach, the rigid member 105 is attached to the leg restraint locking plate 106 by welding. Alternatively, locking plate 106 is integrally formed with the ends of rigid member 105. The mounting bracket 109 and the left and right hand pivot bar brackets 107 and 108 are welded or joined together to create a subassembly. The subassembly, which includes the mounting bracket 109 and the left and right hand pivot bar brackets 107 and 108, are then attached to the rigid member 105 and the locking plates 106 by the mechanical fasteners 118 such that the rigid member 105 may rotate or pivot with respect to the housing from the deployed position to the stowed position and vice versa.

Similar to the torso restraint system, the locking arms 110 are biased by locking arm springs 112 into a locking position and each one of the set of cables 116 is connected to the locking arms 110 at one end and a release mechanism 120 at the other end.

Referring to FIGS. 8 and 11, the mounting bracket 109 is attached to the vehicle 130. Specifically, in the embodiment as shown in FIG. 8 the vehicle 130 includes a mounting surface 160, where the mounting bracket 109 is attached to the mounting surface 160. As illustrated, the mounting surface 160 is located on a backside 162 of a driver's seat 164, however it is understood that the mounting bracket 109 may be attached to other surfaces in the vehicle 130 as well. The backside 162 of driver's seat 164 includes a cavity 166 that receives the leg restraint system 103 such that when the rigid member 105 is in the stowed position as shown in FIG. 8, the leg restraint system 103 is completely located within the backside 162 of the driver's seat 164.

FIG. 11 is a cross-sectional view of the leg restraint system 104 with the rigid member 105 in the deployed position. The bumper 117 abuts against the rigid member 105 when the rigid member 105 is in the deployed position. The bumper 117 is typically constructed from a pliable material such as, for example, rubber or foam. The restraint locking plate 106 includes a first engagement feature 170 and a second engagement feature 172. The locking arm 110 pivots about the locking arm pivot pin 113. The locking arm 110 includes a third engagement feature 176 that selectively engages with one of the first engagement feature 170 and the second engagement feature 172 of the restraint locking plate 106. In the embodiment as shown, the engagement features 170, 172, and 176 are angled mating teeth, however it is understood that other features that can selectively lock and unlock from one another may be used as well.

Specifically, when the rigid member 105 is in the deployed position as shown in FIG. 11, the first engagement feature 170 interlocks with the third engagement feature 176 of the locking arm 110 and secures the rigid member 105 in the deployed position. When the rigid member 105 is actuated into the stowed position (shown in FIG. 8), the first engagement feature 170 is disengaged from the third engagement feature 176 of the locking arm 110. This disengagement is similar to the previous embodiment, wherein actuation of the remotely located actuation device 120 causes the cables 116 to retract and overcome the biasing force of the springs 122, which bias the locking members or locking arms 110 into the locking position. Accordingly, the restraint locking plate 106 and the locking arm 110 perform as a pawl and ratchet assembly.

The second engagement feature 172 of the restraint locking plate 106 interlocks with the third engagement feature 176 of the locking arm 110 and secures the rigid member 105 in the stowed position. Specifically, the locking arm 110 is pivotable about the locking arm pivot pin 113 and is biased into the locking position by the locking arm spring 112 to act as a pawl that selectively engages with one of the engagement features 170 and 172 on the restraint locking plate 106.

In one embodiment the activation or positioning of the leg restraint system 103 into the deployed position (shown in FIG. 9) is manually operated. Referring now to FIG. 10B, the deactivation of the leg restraint system 103 into the stowed position (shown in FIG. 8) is accomplished via cables 116 that are positioned in a remote location via the remote activation device 120. Specifically, the remote activation device 120 is positioned such that the remote activation device 120 can not be accessed by the individual (shown in FIG. 8) that is restrained in the leg restraint system 103. This is because the individual restrained in the leg restraint system 103 may be restrained, such as with handcuffs for example, and may have a limited range of motion represented by the area 150 when the rigid member 105 is in the deployed position. The release mechanism 120 is located in a remote location that is a predetermined distance from the locking mechanism of the leg restraint system 103 such that the release mechanism 120 is outside of the range of motion 150. Thus, the individual restrained within the leg restraint system 104 is unable to grasp the activation device 120. In another embodiment, the activation device 120 may be located in a forward compartment of the vehicle 30 that is separated from the rearward compartment where the restraint device and the restrained individual is located. For example, the forward compartment is separated from the rearward compartment by a dividing wall comprising a portion of the back of the front seat of the vehicle and a screen or transparent member such that rearward compartment can be viewed from the forward compartment.

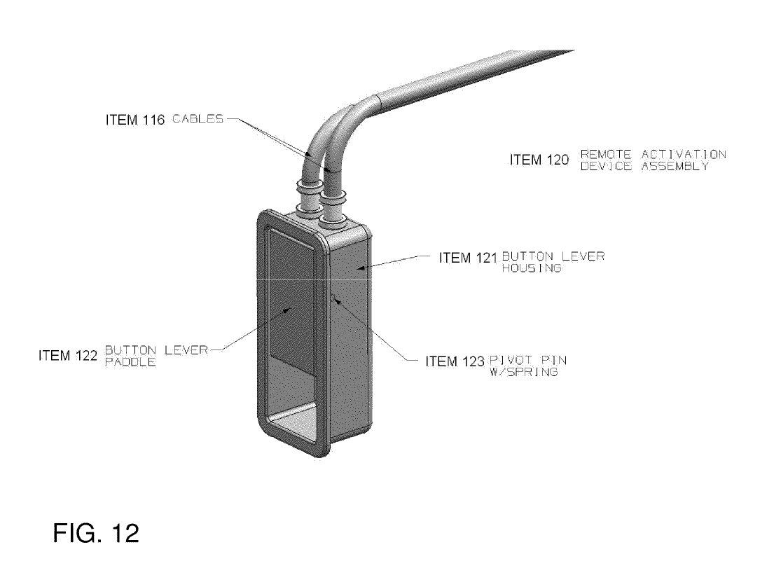

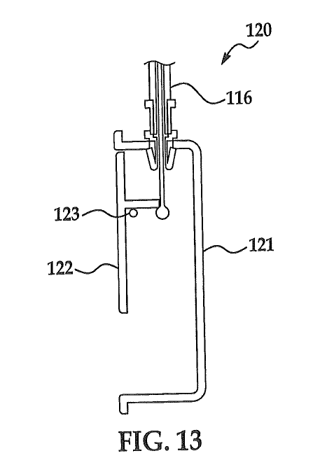

Referring now to FIGS. 12-13, cables 116 pass through an opening located within in a button lever housing 121 and are secured to lever paddle 122 pivotally secured to the button lever housing 121 by a mechanical fastening system 123. In one embodiment, the mechanical fastening system 123 is a pivot pin and spring assembly such that the lever paddle 122 may be pivoted away from the housing 121 and pull the cables 116 such that each locking member 115 is rotated. Thereafter and upon release of the lever paddle 122 the spring 123 will return the lever paddle 122 and the cables 116 back to the unreleased position and the locking members 115 once again moves back to the locking position.

The systems of FIGS. 2-13 significantly improve occupant restraint. The system enables law enforcement or military personal the option to deploy an enhanced restraint system to immobilize the individual thus resulting in a safer environment for transporting the individual. Current vehicles do not provide an option for enhanced restrain and therefore individuals have excessive body movement thus creating an undesirable environment for the individual, the law enforcement personal, and others nearby. This system can be packaged in any passenger vehicle environment.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A restraint system for a body portion of an individual located in a vehicle, wherein the individual moves within a range of motion that is represented by an area of movement, comprising:
a rigid member configured to selectively restrain the body portion, the rigid member being capable of movement between a stowed position and a deployed position, the body portion restrained by the rigid member only in the deployed position;
a locking mechanism for locking the rigid member in the stowed position and the deployed position; and
a release mechanism for activating the locking mechanism, the release mechanism being located at a predetermined distance from the locking mechanism such that the release mechanism is located outside of the area of movement.

2. The restraint system of claim 1, wherein the release mechanism includes a cable system and a housing with a spring biased release paddle, wherein the cable system includes at least one cable that is secured to the spring biased release paddle at one end and the locking mechanism at the other end.

3. A restraint system for an upper body portion of an individual located in a vehicle, wherein the restraint system allows the individual to move within a range of motion that is represented by an area of movement, comprising:
a rigid member configured to selectively restrain the upper body portion, the rigid member being capable of movement between a stowed position and a deployed position, the upper body portion restrained by the rigid member in the deployed position;
a locking mechanism for locking the rigid member in the stowed position and the deployed position; and
a release mechanism for activating the locking mechanism, the release mechanism being located at a predetermined distance from the locking mechanism such that the release mechanism is located outside of the area of movement.

4. The restraint system of claim 3, wherein the vehicle includes a headliner portion, and wherein a portion of the rigid member is generally parallel with the headliner in the stowed position.

5. The restraint system of claim 3, wherein the locking mechanism includes a locking plate and a pivot bracket, wherein a portion of the rigid member is placed between the locking plate and the pivot bracket and is secured to the locking plate and the pivot bracket by a first mechanical fastener, and wherein the rigid member, the locking plate and the pivot bracket create a first sub-assembly.

6. The restraint system of claim 5, wherein the first sub-assembly is attached to a pivot mounting bracket by a second mechanical fastener to create a second sub-assembly.

7. The restraint system of claim 6, wherein the second sub-assembly is attached to an attachment bracket by a third mechanical fastener.

8. The restraint system of claim 7, wherein a spring and a locking arm are provided, and wherein the spring is connected to the attachment bracket and the locking arm.

9. The restraint system of claim 8, wherein the locking arm includes a first engaging feature and the locking plate includes a second engaging feature, and wherein the first engaging feature interlocks with the second engaging feature if the rigid member is in the deployed position.

10. The restraint system of claim 5, wherein a spring is provided for selectively engaging with a detent located along an outer surface the locking plate, wherein engagement between the spring and the detent of the locking plate maintain the rigid member in the stowed position.

11. The restraint system of claim 3, wherein the release mechanism includes a cable system and a housing with a spring biased release paddle, wherein the cable system includes at least one cable that is secured to the spring biased release paddle at one end and the locking mechanism at the other end.

12. The restraint system of claim 3, wherein a restraining housing is provided for at least partially concealing the locking mechanism, and wherein the restraining housing is attached to the vehicle and wherein the rigid member is “U” shaped to surround the upper body portion of the individual.

13. A restraint system for an lower body portion of an individual located in a vehicle, wherein the individual moves within a range of motion that is represented by an area of movement, comprising:
a rigid member configured to restrain a lower body portion of an individual located in the vehicle, the rigid member being capable of movement between a stowed position and a deployed position, the lower body portion restrained by the rigid member only in the deployed position;
a locking mechanism for locking the rigid member in the stowed position and the deployed position; and
a release mechanism for activating the locking mechanism, the release mechanism being located at a predetermined distance from the locking mechanism such that the release mechanism is located outside of the area of movement.

14. The restraint system of claim 13, wherein the restraint system includes a mounting bracket and the vehicle includes a mounting surface that is located on a portion of a seat of the vehicle, wherein the mounting bracket of the restraint system is attached to the mounting surface of the vehicle, and wherein the seat of the vehicle includes a cavity that receives the restraint system such that when the rigid member is in the stowed position the restraint system is completely located within the seat.

15. The restraint system of claim 13, wherein the rigid member is attached to a locking plate that is part of the locking mechanism, and wherein the locking plate includes a first engagement feature and wherein the rigid member has a “U” shaped portion configured to surround a portion of a pair of legs of the individual.

16. The restraint system of claim 15, wherein a locking arm and a locking arm pivot pin are provided, wherein the locking arm selectively pivots about the locking arm pivot pin, and wherein the locking arm includes a second engagement feature.

17. The restraint system of claim 16, wherein the first engagement feature and the second engagement feature interlock with one another to secure the rigid member in the deployed position, and wherein the first engagement feature is disengaged with the second engagement feature in the stowed position.

18. The restraint system of claim 17, wherein the restraint locking plate includes a third engagement feature, wherein the first engagement feature and the third engagement feature interlock with one another to secure the rigid member in the stowed position, and wherein the first engagement feature is disengaged with the third engagement feature in the deployed position.

19. The restraint system of claim 18, wherein the release mechanism includes a cable system and a housing with a spring biased release paddle, wherein the cable system includes at least one cable that is secured to the spring biased release paddle at one end and the locking mechanism at the other end.

20. The restraint system of claim 19, wherein the rigid member is configured to selectively restrain an upper body portion, the upper body portion restrained by the rigid member only in the deployed position; and a second rigid member configured to restrain a lower body portion of the individual located in the vehicle, the rigid member being capable of movement between a stowed position and a deployed position, the lower body portion restrained by the rigid member only in the deployed position; a second locking mechanism for locking the second rigid member in the stowed position and the deployed position; and a second release mechanism for activating the second locking mechanism, the second release mechanism being located at a predetermined distance from the locking mechanism such that the release mechanism is located outside of a second area of movement within the range of movement.
